(19) United States
(12) Patent Application Publication
(10) Pub. No.: US 2009/0284031 A1
(43) Pub. Date: Nov. 19, 2009

(54) DEMOUNTABLE TONGS

(75) Inventors: Bernhard Pavicsits, Wollersdorf (AT); Gunter Hermann, Eisenstadt (AT)

Correspondence Address: LADAS & PARRY LLP, 26 WEST 61ST STREET, NEW YORK, NY, 10023, US

(73) Assignee: POCHTLER MANAGEMENT GMBH & CO KG.

(21) Appl. No.: 12/464,911

(22) Filed: May 13, 2009

(30) Foreign Application Priority Data
May 16, 2008 (AT) A 789/2008

(51) Int. Cl. B25B 9/00; B25B 7/06

(52) U.S. Cl. 294/16; 294/99.2

(57) ABSTRACT

A pair of tongs of the type used in the kitchen and elsewhere has hingedly connecting arms that are biased apart by a spring. The spring is releasably connected to one arm and abuts against the second arm. The arms and spring can be fully separated from each other to facilitate cleaning and reassembly.

The invention relates to tongs having a first tongs arm and a second tongs arm which are hingedly connected together, wherein at least one spring is provided which pushes apart the first tongs arm and second tongs arm in the condition of non-actuation.

Countless tongs of this kind, mainly for kitchen use, are already customary. For example, U.S. Pat. No. 7,086,676 B2 discloses a kitchen tongs of this kind, which is subject to the action of a coil spring and which is adjustable by means of a coupling. Similarly, US 2007/0130034 A1 discloses tongs which have a coil spring and which are adjustable into closed and open positions. U.S. Pat. No. 6,056,338 and U.S. Pat. No. 6,726,263 also disclose tongs of a similar design. Further kitchen tongs are also disclosed in U.S. Pat. No. 6,089,631 and WO 2004/039228 A1.

WO 1999/09870 A1 discloses a food tongs which has two tong limbs, a spring tongue being formed in one piece on the one tongs limb and resting against the other tongs arm.

Since tongs like these are usually used in the kitchen domain, are made of very diverse materials, and come into contact with diverse perishable and non-perishable goods and products, hygiene is of the utmost importance with the manufacture and sale of kitchen utensils. Since the tongs known from the prior art consist of a large number of small and extremely small component parts between which dirt and perishable matter can collect, cleaning the tongs needs a lot of effort. In particular, despite rigorous washing and cleaning, it is not possible to guarantee cleanliness and hygiene which is adequate for re-use, since these parts of the tongs have regions which are inaccessible and which cannot be reached. In particular, the use of these tongs in large-scale catering is subject to strict conditions, and straightforward, thorough washing has to be guaranteed.

The aim of the invention is therefore to provide tongs which offer an improvement over the prior art, and which are easy to use. Another aim of the invention is to create tongs which are suitable for kitchen use, easy to wash, and which are such that dirt can be removed from all parts of the tongs easily and with the minimum of residues being left behind.

This problem is solved according to the invention in that the spring is releasably connected to the first tongs arm and rests against the second tongs arm, so that the tongs arms can be released from each other and then connected back together by hand. As a result, all component parts—that is to say, at least both of the tongs arms and the spring—can be separated, so that there are no inaccessible areas formed in the tongs where dirt can easily collect. In particular, the fact that the tongs can be taken apart means that the individual component parts can be put in a dishwasher, thereby achieving hygienic and thorough cleansing. In particular, the invention prevents places which are not easily accessible, particularly in the region where the two tongs arms are connected together, from remaining dirty. If not taken apart, even after thorough cleaning in a dishwasher it would not be possible to remove all dirt, particularly perishable food residues and bacteria. Also, it is an advantage if the dismantling can be done without the use of a tool.

According to one embodiment, it is provided that the second tongs arm has an abutment element by way of which the spring biases the second tongs arm, and the first and second tongs arms are hingedly connected by means of a pin which forms the hinge axis. Therein, it is preferable if the pin is fixedly arranged on one of the tongs arms, preferably on the first tongs arm, or is designed so that it is in one piece therewith. As a result, no deposits of dirt can form between the pin and the tongs arm.

A further embodiment provides that the second tongs arm has a guide by way of which said arm is guided on the pin so that the spring holds the second tongs arm in the locked position in the guide which preferably has a notch. Therefore, in the assembled condition, the guide and the pin hold the two tongs arms together despite the fact that they are being pushed apart by the spring. However, this locked position can be re-released by virtue of the spring force being surmounted, wherein by pushing away the spring from the abutment element of the second tongs arm the tongs arms can be released from each other by virtue of the second tongs arm moving along the guide.

A further embodiment provides that the tongs has an opening limiter device, wherein the opening limiter device is guided by way of a guide on the pin of the first tongs arm, and permits positioning of the tongs arms relative to each other, up to a given maximum angle of opening. This maximum angle of opening is, preferably, about 45°, but can be substantially more or less, depending upon the purpose of use. Preferably, the opening limiter device is designed such that it permits at least two angles of opening of the tongs arms relative to each other. Therein, the tongs can be moved into the desired position of opening either by actuating the opening limiter device or by moving the tongs arms apart by hand.

One embodiment provides that the opening limiter device is designed as a sliding clutch with teeth which can lock in place against (latch into) at least a counter-tooth of a tongs arm. Thus, by adjusting the opening limiter device through different positions of the teeth in relation to counter-teeth, it is possible to control the maximum angle of opening of the tongs arms relative to each other.

A preferred embodiment provides that spring is designed as a bent, elongate, steel bow spring, formed in one piece, guided substantially along one tongs arm, and with a high degree of inherent rigidity. This design of the spring essentially along one tongs arm—unlike the prior art—primarily serves to avoid having the spring arranged directly in the hinge region of the tongs, thus avoiding serious dirtying and poor accessibility of the spring. It is also easier to clean extended springs than helical springs. As an alternative to this bow spring, it is also possible to use a leaf spring, or similar. The main thing of importance with respect to the spring is that it is detachably connected, or biased, to a tongs arm, on the one hand, and is in abutment with, or biases the respective other tongs arm, on the other hand.

According to one embodiment it can be provided that the spring preferably rests against the abutment element of a tongs arm by way of a plastic nub. The other region of the spring, which is actually springy, is clamped releasably to the other tongs arm. When the tongs arms are actuated by manual pressure, the spring becomes deformed, counter to its inherent rigidity, over the abutment element of one tongs arm. When the actuation is relaxed again, the spring moves the tongs arms over the stop member, back into an angle of opening which has been established by the opening limiter device. The spring does not have to have a plastic nub, but can be shaped such that it has a retaining lug, so that this region rests against the abutment element.

According to a preferred embodiment, it is provided that the tongs can be taken apart into first tongs arm, second tongs arm, spring and opening limiter device.

With respect to the taking apart of the tongs it is advantageous if the tongs is demountable from its open position, since only in that position it is possible to activate the plastic nub. In general, it is preferably provided that the tongs have three angles of opening (α, β and γ), wherein a describes the maximum angle of opening, β describes the angle of closure, and γ describes an angle of opening lying therebetween. In this respect, β is preferably a maximum of 5°, α is preferably a maximum of 45°, and γ is preferably between 10 and 20°. Alternatively, it is possible to have yet more settable angles of opening.

Further details and advantages of the present invention will be described in greater detail hereinafter with the aid of the description of the drawings, given with reference to the embodiments shown in the drawings. In the drawings:

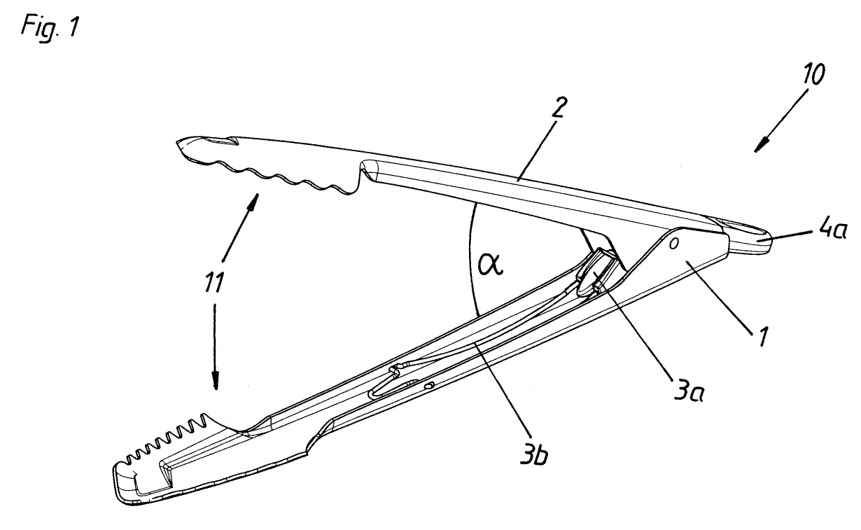

FIG. 1 is a view of the assembled tongs,

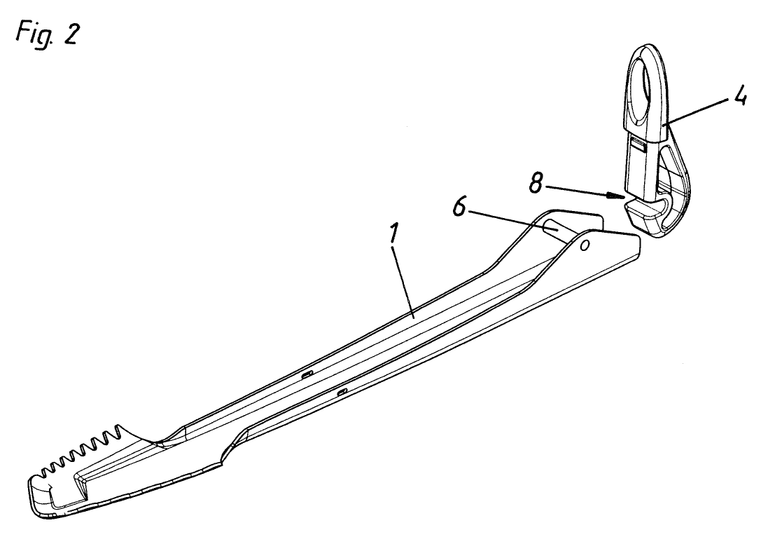

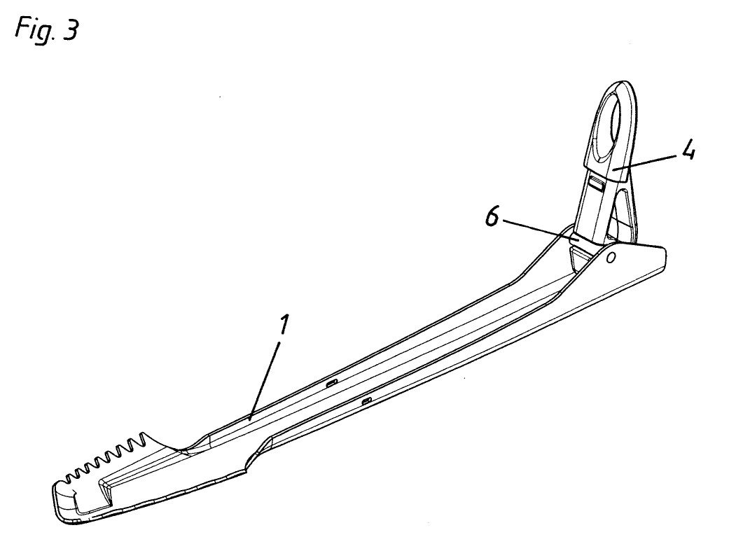

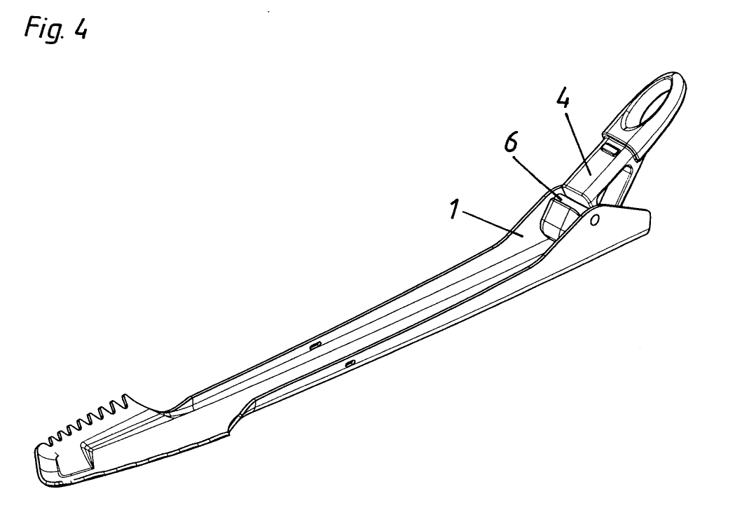

FIGS. 2, 3, 4 show the arrangement of the opening limiter device on the first tongs arm,

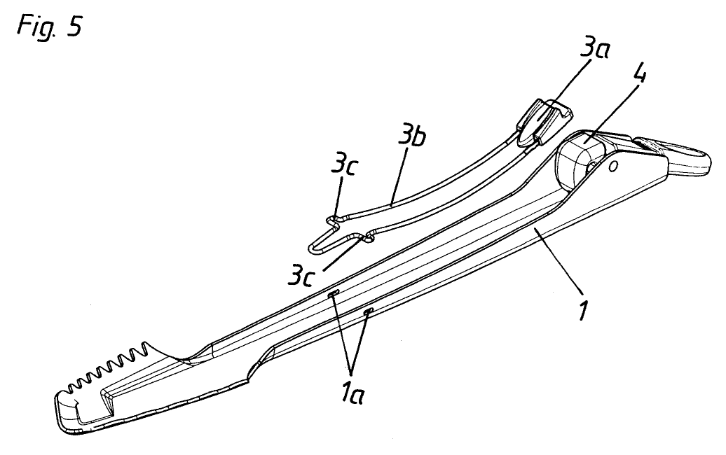

FIG. 5 shows the insertion of the spring into the first tongs arm,

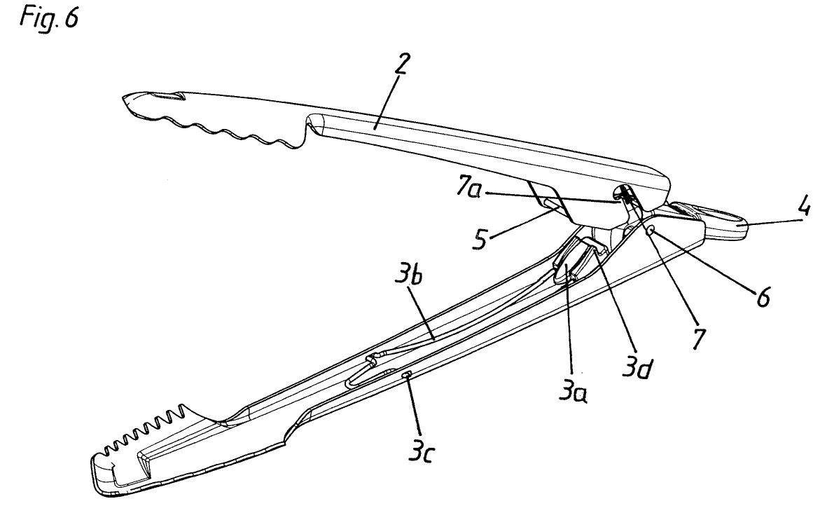

FIG. 6 shows the arrangement of the second tongs arm,

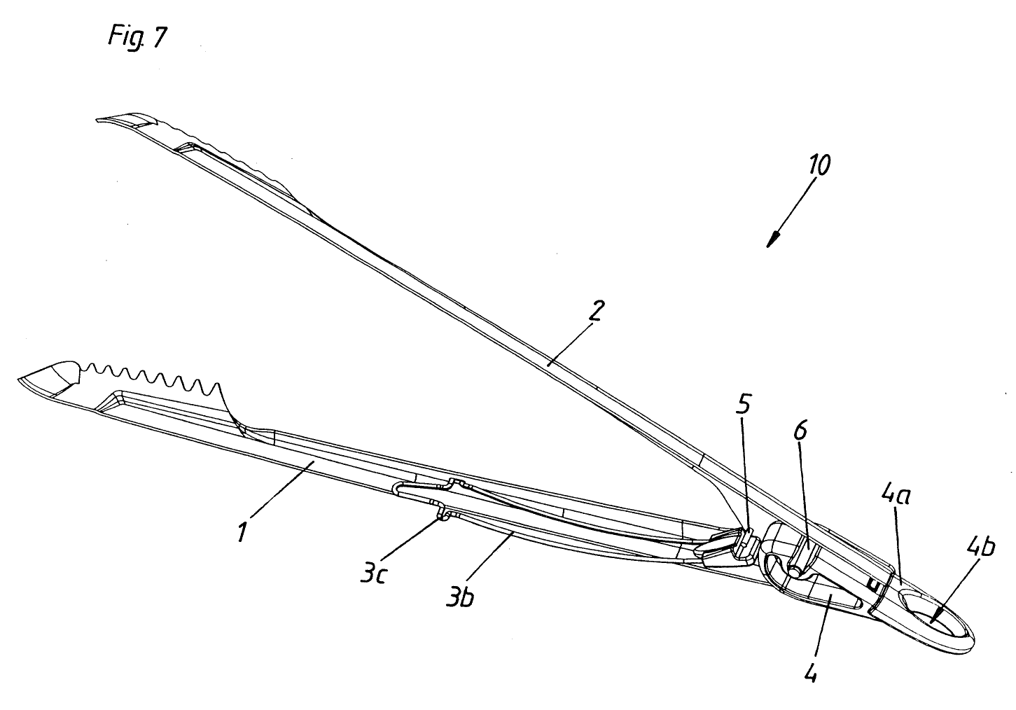

FIG. 7 is a partially open view of the tongs mechanism,

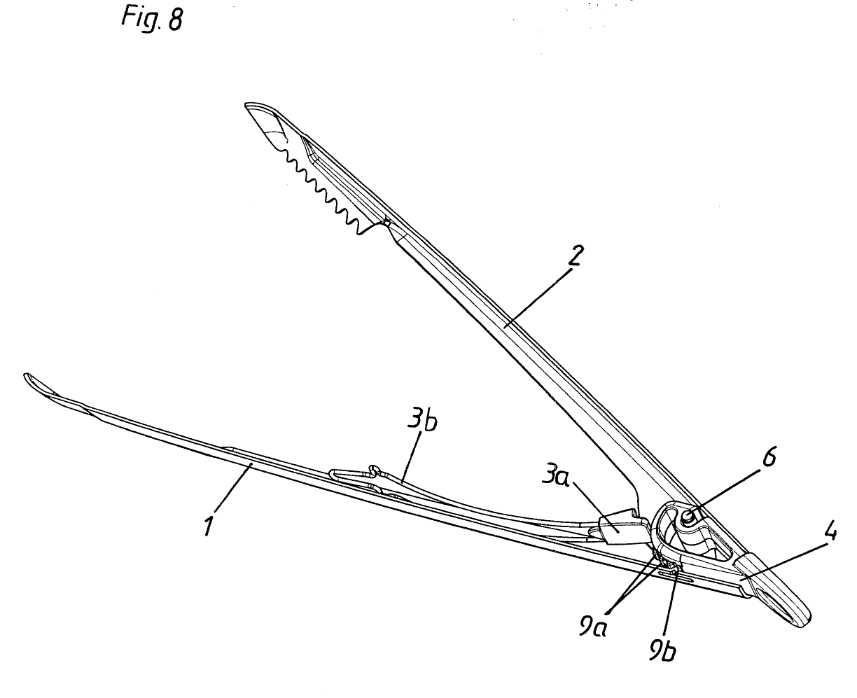

FIGS. 8 & 9 are partially open views of the tong mechanism with sliding clutch,

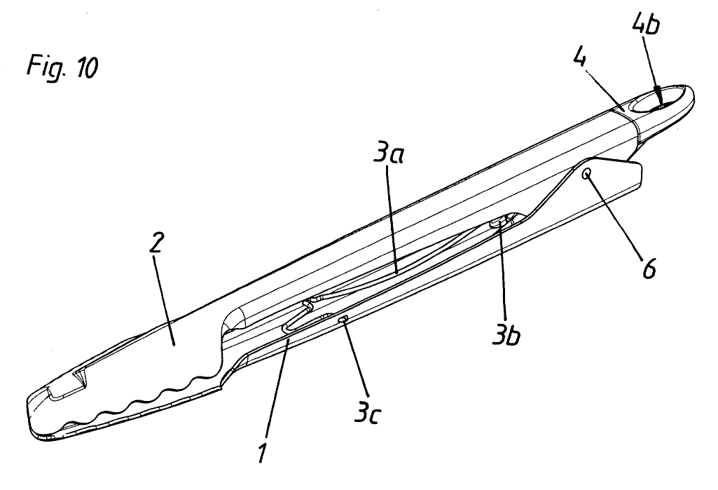

FIG. 10 is a view of the closed tongs,

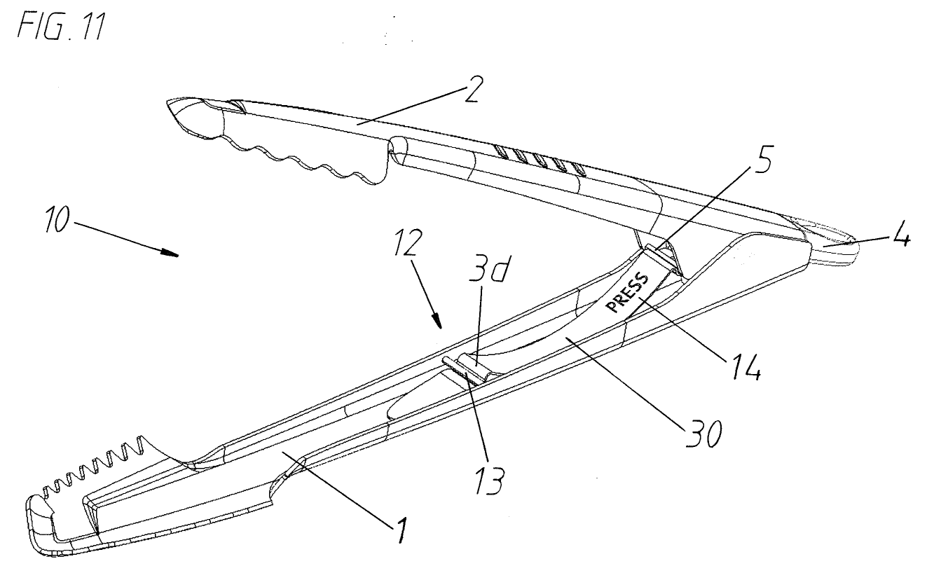

FIG. 11 is a view of the assembled tongs with leaf spring, and

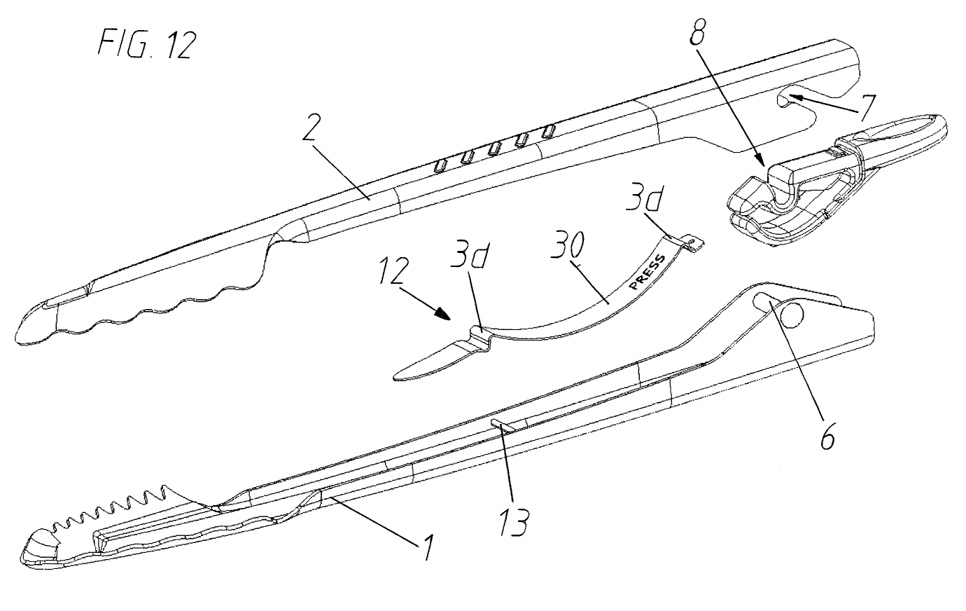

FIG. 12 is a view of the four dismantled component parts of FIG. 11.

In the following description of the drawings, tongs arm 1 and tongs arm 2 are always clearly differentiated from each other, but as far as the inventive concept is concerned the arm on which the component parts of the tongs mechanism are arranged, or lie, is unimportant. The purpose of differentiating between tongs arm 1 and tongs arm 2 is primarily for the sake of making the description clearer and simpler.

FIG. 1 shows the tongs 10 with tongs arm 1 and tongs arm 2 hingedly connected together, and the spring 3 consisting of the plastic nub 3a and curved region 3b. In the region of the hinge, it is possible to see the adjustment handle 4a of the opening limiter device 4 which holds the tongs 10 at the maximum angle of opening α, the actual value being 28°. The ends 11 of the tongs arms 1 and 2 which are gripped can be adapted in respect of their shape to the desired use. Provision can also be made for the gripping ends 11 to be able to be changed over.

FIGS. 2 to 4 show the connection between the opening limiter device 4 and the tongs arm 1. The opening limiter device 4 has a guide 8, which, when in place, partially encloses the pin 6 of tongs arm 1.

FIG. 5 shows a view of tongs arm 1 with the opening limiter device 4, already arranged therein, and in the position of maximum opening. Tongs arm 1 has two retaining openings 1a in which the clamping teeth 3c of the spring 3 can be retained or placed. The retaining teeth 3c form part of the curved bent region 3b of the spring 3, the curved region 3b emanating from the plastic nub 3a of the spring 3 and terminating therein.

FIG. 6 shows the spring 3 in the state of use in tongs arm 1, with the retaining teeth 3c inserted into the retaining openings. The connection is made easily by virtue of the fact that the spring 3 is guided, or slides, along the tapering arm of the tongs as far as the retaining openings 1a. By virtue of the tapered configuration, the spring 3, and, in particular, the retaining teeth 3c, are squeezed laterally, or compressed, thereby causing them to become clamped in the retaining openings 1a upon reaching them. The opening limiter device 4 is designed in such a way that between the opening limiter device 4 and the tongs arm 1, it is still possible for the tongs arm 2 to be connected to the pin 6. In this respect, the tongs arm 2 is brought over the two-sided guide 7, which has the notch 7a, so that it abuts on the pin 6. The tongs arm 2 also has an abutment element 5 facing in the direction of the spring 3. Before it is assembled, the spring 3 has a relatively sharp curvature (not shown), and so the spring 3 already bears against tongs arm 2. The closer the tongs arm 2 is guided towards the assembled position, the greater the extension of the spring 3. When tongs arm 2 reaches the assembled position, the abutment element 5 springs over the retaining lug 3d of the spring 3 into the stop position. By virtue of the tapered configuration of the spring 3, or plastic nub 3a, in the region of the retaining lug 3d, the spring 3 is guided on the abutment element 5 in such a way that in the assembled condition the spring 3 is unable to spring out of that position by itself.

FIG. 7 shows a part sectional view through the fully assembled tongs 10. In this drawing it is possible to see the way in which the plastic nub 3a of the spring 3 biases tongs arm 2 by way of the abutment element 5. Since tongs arm 2 is held by its guide 7 against the pin 6 in the locked position, the tongs arm 2 is able to move only as far as the maximum angle of opening set by the opening limiter device 4. Thus, by actuating the tongs arm 2 a pivotal movement of tongs arm 2 about the pin 6 takes place, the spring 3 with its plastic nub 3a and opening limiter device 4 restricting the movement capabilities of tongs arm 2, or, rather, holding it at given angles. By manually pushing the plastic nub 3a away from the stop member 5, for example, the tongs arm 2 no longer has the two limits imposed by the pin 6 and opening limiter device 4, and by guiding tongs arm 2 along the guide 7 (see FIG. 6) the tongs arm can be fully released from the rest of the tongs. Following removal of tongs arm 2, the opening limiter device 4 and spring 3 can also be released without further ado from tongs arm 1, and thus washed and cleaned as individual parts. The opening limiter device 4 has in the rear region thereof an adjustment handle 4a and a hole 4b for hanging provided therein. That region serves, on the one hand, for hanging up the tongs 10 as a whole, and, on the other hand, for suitable adjustment of the maximum angle of opening, as will be described in greater detail in FIG. 8.

FIG. 8 shows a partially open view of the tongs mechanism, from below, four teeth 9a being disposed there, on the underside of the opening limiter device 4, into which teeth 9a a counter tooth 9b of tongs arm 1 engages. By using the adjustment handle 4a to shift the opening limiter device 4 about the hinge axis of the pin 6, the teeth 9a are able to move, or slide, between various positions relative to the counter-tooth 9b. In this respect, there are three grooves between the four teeth 9a, each of which grooves receives the counter-tooth 9b, each groove representing a different angle of opening. The maximum angle of opening is shown in FIG. 8.

As an alternative, but not shown, the teeth 9a can be flatter on one side and steeper on the other side, so that during the closure movement of the tongs arms 1 and 2 there is less resistance than during opening. An alternative design of the tongs can be that they are without such teeth 9b and thus having a relatively smooth surface ensure different adjustable angles simply by friction, the friction in the region of contact between the opening limiter device 4 and tongs arm 1 being greater than the spring force of the spring 3. The coupling can also be designed in the form of a spring coupling.

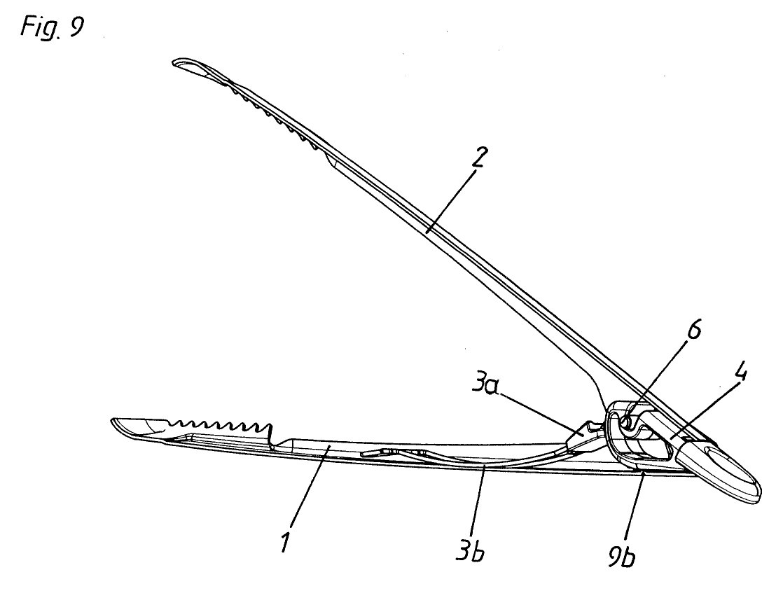

FIG. 9 shows the tongs 10 of FIG. 8 from a different perspective. FIG. 10 shows the tongs 10 in the closed position, that is to say at the closed angle.

FIG. 11 shows a tongs 10 with the spring 3 in the form of a leaf spring 30. This leaf spring 30 has a pressure region 14 which corresponds roughly to the region and function of the plastic nub 3a of FIGS. 1 to 10. The leaf spring 30 is held detachably (retaining region 12) to the tongs arm 1, firstly, by means of a retaining lug 3d and a corresponding clamping member 13, and, secondly, it rests by way of the other retaining lug 3d against the abutment element 5 of the second tongs arm 2.

FIG. 12 shows the dismantled tongs 10 of FIG. 11 which comprises four component parts. The leaf spring 30 has the two retaining lugs 3d which permit the relative biasing of the tongs arms 1 and 2, acted upon by the leaf spring 30, by way of the abutment element 5 on the tongs arm 2 and by way of the clamping member 13 on the tongs arm 1 (retaining region 12).

The invention which has been described here therefore discloses a spring-loaded tongs, the essential feature of which is that it is able to be taken apart without the use of a tool, whilst, at the same time, being simple to use. Additional features of the tongs are the variable adjustment of the width of opening by means of a type of coupling, and the simple release mechanism for ensuring that the tongs can be taken apart. Demounting is made possible by purposefully pressing down the spring, or the plastic nub thereof, whereby the tongs arm is able to be removed along the introduction slot, whereupon the spring and the coupling member can then be separated, free of any complication, from the other tongs arm. All surfaces of the component parts of the tongs are designed such that there are no “hiding places”, and so a hygienic kitchen utensil is created which is easy to clean and which meets all requirements from private household to large-scale catering.

1. Tongs having a first tongs arm and a second tongs arm which are hingedly connected together, wherein at least one spring is provided which pushes apart the first tongs arm and second tongs arm in the condition of non-actuation, wherein the spring is releasably connected to the first tongs arm and abuts on the second tongs arm, so that the tongs arms are manually releasable from each other and are manually reassemblable.

2. Tongs according to claim 1, wherein the second tongs arm has an abutment element by way of which the spring biases the second tongs arm.

3. Tongs according to claim 1, wherein the first and second tongs arms are hingedly connected by means of a pin which forms the hinge axis.

4. Tongs according to claim 1, wherein the pin is fixedly arranged on one of the tongs arms or formed integrally with one of the tongs arms.

5. Tongs according to claim 1, wherein the second tongs arm has a guide by way of which said arm is guided on the pin such that the spring holds the second tongs arm in a locked position in the guide which preferably has a notch.

6. Tongs according to claim 5, wherein the guide has a notch.

7. Tongs according to claim 1, wherein the locked position is re-releasable by virtue of the spring force being surmounted.

8. Tongs according to claim 1, wherein by manually releasing or pushing away the spring from the abutment element of the second tongs arm, the tongs arms are releasable from each other by virtue of the second tongs arm moving along the guide.

9. Tongs according to claim 1, wherein the tongs has an opening limiter device.

10. Tongs according to claim 9, wherein the opening limiter device is guided by way of a guide on the pin of the first tongs arm, and permits positioning of the tongs arms relative to each other, up to a predefined maximum angle of opening (α).

11. Tongs according to claim 9, wherein the opening limiter device permits at least two angles of opening (α, β) of the tongs arms relative to each other.

12. Tongs according to claim 9, wherein the opening limiter device is designed as a sliding clutch with teeth which can lock in place against at least one counter-tooth of a tongs arm.

13. Tongs according to claim 1, wherein the spring is designed as a bent, elongate, steel bow spring or leaf spring, formed in one piece, guided substantially along a tongs arm, and with a high degree of inherent rigidity.

14. Tongs according to claim 13, wherein the spring abuts by way of a retaining lug against the abutment element of a tongs arm, and the bent region of the spring is clamped releasably to a tongs arm, wherein upon actuation of the tongs arms by pressing said tongs arms towards each other the spring becomes deformed over the abutment element counter to its inherent rigidity, whereas in the condition of non-activation of the tongs arms the spring moves the tongs arms with abutment element into the angle of opening predefined by the opening limiter device.

15. Tongs according to claim 1, wherein the tongs is demountable into first tongs arm, second tongs arm, spring and opening limiter device.

16. Tongs according to claim 1, wherein the tongs is demountable without the use of a tool from any position of the angle of opening.

17. Tongs according to claim 16, wherein the tongs is demountable only from the open position of the angle of opening.
